(19) United States
(12) Patent Application Publication
(10) Pub. No.: US 2013/0204671 A1
(43) Pub. Date: Aug. 8, 2013

(54) SYSTEM AND METHOD FOR RESEARCH ANALYTICS

(71) Applicant: Niels Weertman, Amsterdam (NL)

(72) Inventor: Niels Weertman, Amsterdam (NL)

(73) Assignee: Elsevier Inc., New York, NY (US)

(21) Appl. No.: 13/698,240

(22) PCT Filed: May 31, 2011
(86) PCT No.: PCT/US11/38545

§ 371 Date: Feb. 14, 2013

Related U.S. Application Data
(60) Provisional application No. 61/349,980, filed on May 31, 2010.

(51) Int. Cl. G06Q 10/06

(52) U.S. Cl. CPC G06Q 10/0637
USPC 705/7.36

(57) ABSTRACT

Described is a system and method for research analytics. A system comprises a database storing citation data for a plurality of publications and a server identifying a subset of publications from the plurality of publications based on the citation data. The server generates clusters of publications from the plurality of publications based on a comparison of the citation data for the subset of publications to the citation data for a remainder of the plurality of publications. The server assigns a general subject area and a discipline to each of the clusters, and the server generates a graphical representation of the clusters based on the general subject area and the discipline assigned thereto.

This application claims priority to U.S. Provisional Patent Application No. 61/349,980 filed on May 31, 2010, the entire contents of which are hereby incorporated by reference.

### TECHNICAL FIELD

The present invention relates to systems and methods for research analytics. In particular, the exemplary embodiments of the present invention relate to systems and methods for presenting and analyzing research publication and funding data.

### BACKGROUND OF THE INVENTION

At research institutions and companies, research capabilities traditionally have been assessed based on conventional measures which were designed around the paradigm of distinct fields of research, are narrowly focused, and generally lead to perpetuating established areas of research, while ignoring or giving less attention to emerging and/or multidisciplinary areas of research. In the modern research environment, however, research usually is multidisciplinary in nature and new technologies develop rapidly.

Current metrics and systems of research evaluation fail to adequately address these trends. For example, research output is traditionally evaluated based on the classification of the journals in which articles are published, even though these journals cover a wider range of disciplines than are reflected in their classification. Additionally, using conventional metrics, an institution is more likely to allocate significant resources to support an established researcher or research group that generally obtains funding and has findings published in prestigious journals. Thus, under present systems, only a simplistic and inaccurate view of an institution's research initiatives can be obtained. As a result, valuable resources may not be put to their best use, collaboration opportunities can be missed, and emerging research trends can go undiscovered.

During the last several years, as publication and citation data became more accessible, a number of advanced statistical techniques have been applied to this information, such as co-citation analysis to obtain “clusters” of publications. The resultant data, however, provided limited real world application because of the difficulty of processing and interpreting this information.

There remains a need for more suitable metrics and tools which allow decision-makers to gauge and evaluate research output in a meaningful way. Such metrics and evaluation tools could utilize advanced statistical techniques.

A related problem to evaluating research is obtaining funding for research. It has been challenging to bring an institution's research strengths to light as traditional assessment methodologies, as discussed above, cannot account for the multidisciplinary nature of research today. This often leaves important work overlooked and thus underfunded. Additionally, funding resources are very limited. Only one in five funding proposals is accepted in the U.S. with the ratio being even lower for junior researchers. Thus, it is important to choose carefully which funding opportunities to pursue to maximize limited time and resources. Present tools used to narrow the search for funding are generally difficult to use, deliver too many irrelevant results, lack relevant historical data, and/or require manual setup and maintenance of profiles. There remains a need for a tool that effectively presents relevant funding opportunities to researchers and administrators, in an efficient manner.

### SUMMARY OF THE INVENTION

The present invention in one embodiment describes a system and method for research analytics. A system comprises a database storing citation data for a plurality of publications and a server identifying a subset of publications from the plurality of publications based on the citation data. The server generates clusters of publications from the plurality of publications based on a comparison of the citation data for the subset of publications to the citation data for a remainder of the plurality of publications. The server assigns a general subject area and a discipline to each of the clusters, and the server generates a graphical representation of the clusters based on the general subject area and the discipline assigned thereto.

It is noted that the underlying co-citation and clustering algorithms, described briefly in the preceding paragraph, were developed by SciTech Strategies (see http://mapofscience.com/index.html). Applicant recognizes and acknowledges this pre-existing and impressive technology and makes no claim to any aspect of this technology which was created prior to and without contribution by the inventors herein, including any of the pre-existing SciTech algorithms, or obvious modifications of these established algorithms. Applicant's invention is directed to Applicant's unique implementations of one or more variations of these algorithms for specific tasks and operations as described in more detail below. As an illustration, this includes the streamlined web-based interface and selectively configured processing of the application of an algorithm for determining competencies within an institution that are underfunded or overfunded.

The present invention, in yet another embodiment, provides a server supporting an evaluation tool. This tool, using the data and graphics generated, allows decision-makers to:

| | |
|---|---|
| (1) | evaluate strategic decisions regarding research |
| (2) | assess allocation of internal funding |
| (3) | identify and capitalize on emerging areas of research |
| (4) | compare research capabilities and output with peers and |
| | competitors |
| (5) | identify areas for multidisciplinary research |
| (6) | identify which researchers should be recruited/retained |
| (7) | identify which people/institutions are the best potential |
| | collaborators |

The present invention in a further arrangement also provides a system and method to facilitate the identification and optimization of research funding opportunities. In this arrangement, the server may provide a funding tool which allows the user to:

| | |
|---|---|
| (1) | determine which opportunities are the most relevant to them |
| (2) | determine whether an opportunity is worth pursuing |
| (3) | stay up to date on new and emerging funding opportunities |
| (4) | determine the most important researchers in the field |
| (5) | determine what research projects were awarded in the past |
| (6) | determine which publications are related to past awards |

### BRIEF DESCRIPTION OF THE FIGURES

A more complete understanding of the system and method of the present invention may be obtained by reference to the following Detailed Description when taken in conjunction with the accompanying Figures wherein:

FIG. 1 shows an exemplary embodiment of a system for research analytics according to the present invention;

FIG. 2 shows an exemplary embodiment of a method for research analytics according to the present invention;

FIG. 3 shows an exemplary embodiment of an output of a display module according to the present invention;

FIG. 4 shows an exemplary embodiment of an output of a display module according to the present invention;

FIG. 5 shows an exemplary embodiment of an output of a display module according to the present invention;

FIG. 6 shows an exemplary embodiment of an output of a display module according to the present invention;

FIG. 7 shows an exemplary embodiment of an output of a display module according to the present invention;

FIG. 8 shows an exemplary embodiment of a funding interface according to the present invention;

FIG. 9 shows an exemplary embodiment of a funding recommendation page according to the present invention.

FIGS. 10a-c show exemplary embodiments of funding program pages according to the present invention.

### DETAILED DESCRIPTION OF THE INVENTION

The present invention may be further understood with reference to the following description and the appended drawings, wherein like elements are referred to with the same reference numerals. The components described hereinafter as making up various elements of the invention are intended to be illustrative and not restrictive. Many suitable components that would perform the same or similar functions as the components described are intended to be embraced within the scope of the invention. Such other components can include, for example, components developed after development of the invention.

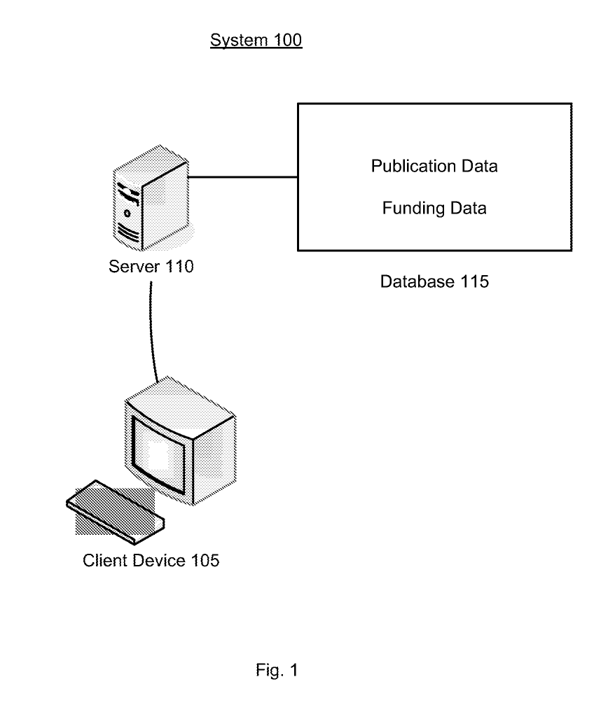

FIG. 1 shows an exemplary embodiment of a system 100 for research analytics according to the present invention. The system 100 may comprise a client device 105 communicatively coupled to a server 110, which has access to a database 115. Those of skill in the art will understand that there may be any number of client devices 105, servers 110 and database 115 in other embodiments of the system 100.

In one exemplary embodiment, a research analytics program may be one or more software modules stored on the server 110, and the client device 105 may include a browser for allowing a user to access the research analytics program. In this embodiment, the research analytics program may be accessed by a plurality of different users at a plurality of different geographic locations. Different users may be provided with different levels of access to data in the database 115 or different sets of data depending upon, for example, authentication information (e.g., a username and password) entered by the user. That is, in this exemplary embodiment, the user may be required to register with the research analytics program and log-in each time it is used. The database 115 may store a profile associated with each registered user (or group of users, e.g., individuals at an institution may utilize a single profile). In this embodiment, the research analytics program may be “web-based” (accessible via a URL) and the modules may be implemented in any one or more different programming languages such as Java, JavaScript, PHP, Python, etc. The database 115 schema and access thereto may be written in SQL or any other database-query language.

In another exemplary embodiment, the research analytics program may be stored on the client device 105. In this exemplary embodiment, the program may be downloaded from the server 110 or available as a stand-alone program (e.g., on a disc or other storage medium). The client device 105 may connect to the server 110 in this embodiment when, for example, there is an update package available for download and/or when a user desires to download/upload information from/to the database 115. Those of skill in the art will understand that the program may be implemented in a variety of programming language such as Java, C, C++, etc.

The database 115 may store publication data (e.g., research publications, authors, authors' institution/company affiliations, references cited, citing references, publication name/year, etc., article topic keywords) and funding data (e.g., funding programs, funding requests, funding awards, research publications related to funding awards, principal investigators, etc.). The data in the database 115 may be entered by a source (e.g., a researcher, academic executive, funding source) or by a third-party (e.g., a publication administrator, a funding program administrator, general public, etc.). Additionally, the data in the database 115 may be gathered by an automated process, such as a web crawler. Those of skill in the art will understand that the database 115 may store additional data (e.g., user profiles) utilized or generated by the system 100.

In the exemplary embodiment, the user may be an executive or decision-maker at a research institution or company who utilizes the research analytics program for analyzing data contained in the database 115. For example, at a research institution, the executive may be tasked with assessing individual and departmental research output, allocating internal funding, analyzing competitor institutions' researcher and output, identifying opportunities for multi-disciplinary and/or multi-entity research, and/or recruiting new research faculty. The system 100 of the present invention may allow the executive to accomplish all of those tasks via a single interface.

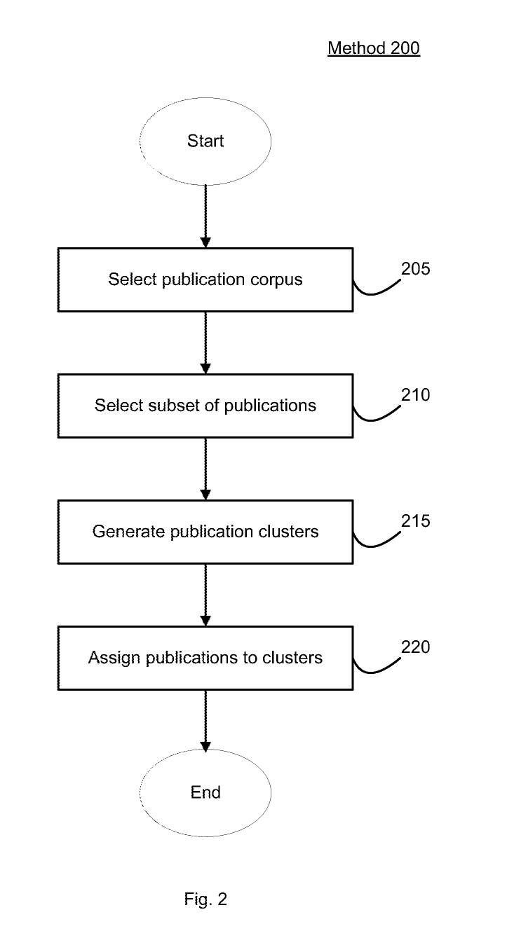

FIG. 2 shows an exemplary embodiment a method 200 for research analytics according to the present invention. While the description of the method 200 may refer to components of the system 100, those of skill in the art will understand that embodiments of the method 200 are not limited to the devices described with reference to the exemplary embodiments of the system 100. For example, various hardware and/or software may be used to implement the method 200. Similarly, the method 200 may be a set of instructions (or one or more modules) which are stored on a computer readable medium and executable by a processor.

The exemplary embodiment of the method 200 may be utilized by a user to generate output for visualizing an overall research capability (“research fingerprint”) of an institution or company. The research fingerprint may provide visual indicators (along with alphanumeric data) which allow the user to evaluate and understand the research capabilities and output of the institution or company and competitors.

In step 205, a publication corpus is selected. In an exemplary embodiment, the selection may be configured to include all publications for a given time period, subject matter, geography, institution, author, publication, etc. Publication data (e.g., author(s), publication source, year, title, abstract, full-text, keywords, citations (forward and/or backward), tags, etc.) for each publication in the corpus may be stored in the database 115. For example, the publications may be electronic documents which are input to a recognition module (e.g., OCR, parsing to identify particular fields, etc.) or manually deconstructed to input the publication data into the database 115. As understood by those of skill in the art, the selection of the publication corpus may be set to default parameters (e.g., all publications published in peer-reviewed journals over a one year time period) and generated automatically or be customized by time period, subject matter, geography, institution, author, publication, etc.

In step 210, a subset of the publications from the publication corpus is selected based on citation data. Each publication in the publication corpus has corresponding publication data which may include the citation data identifying reference publications that were cited in the publication. In the exemplary embodiment, the citation data for each publication in the publication corpus is identified and stored in the database 115. This may generate a list of numerous reference publications. The subset may be identified by comparing a frequency with which each of the reference publications is cited to a predetermined threshold. For example, if reference publication X is cited by 20 of the publications in the publication corpus and 20 is greater than the predetermined threshold, reference publication X may be included in the subset. In an exemplary embodiment, the predetermined threshold may be selected based on publication date of the reference publication. For example, reference publications published more than 3 years ago may have a higher predetermined threshold than reference publications published less than 3 years ago. By varying the predetermined threshold based on the publication date, emerging trends in research may be identified.

In step 215, publication clusters are generated using the publications in the subset. The clusters may indicate whether the subject matter of given publications are “related.” Thus, the clusters may represent specific areas of research. In an exemplary embodiment, the clusters may be generated by calculating relatedness data for the publications in the subset. The relatedness data may be calculated using a co-citation analysis on the citation data for the publications in the subset and the other publications in the corpus. One exemplary method for calculating the relatedness data is a modified cosine indices based on co-citation counts for similarity and running a resulting matrix of cosine values through a visualization program (e.g., a force-directed placement algorithm with edge cutting, such as a DrL method, formerly known as VxOrd) which assigns each publication an (x,y) position on a 2-D plane. In another exemplary embodiment, the relatedness data may be calculated using the visualization program a predetermined number of times and averaging (or generating a consensus value) of the results. For example, as those of skill in the art will understand, the DrL method is a random walk routine, and thus, the use of different starting conditions may generate slightly different results. By running the DrL method more than one time, for example, there may be a difference in the relatedness data indicating that given references are “close” or “distant.”

A clustering algorithm may be used with output from the visualization program to generate the clusters. In one exemplary embodiment, a supervised clustering algorithm may be used. As understood by those of skill in the art, the supervised clustering algorithm may be trained using training data and comparing an actual output to an expected output. The supervised clustering algorithm is iteratively revised until the actual output matches the expected output. In another exemplary embodiment, an unsupervised clustering algorithm is used. As understood by those of skill in the art, the unsupervised clustering algorithm may not use training data. A user (or programmer) may specify a predetermined number of clusters to be output by the unsupervised clustering algorithm or allow the publications to self-organize into emergent groupings, e.g., agglomerative clustering, based on the citation data of the publications in the subset. One exemplary unsupervised clustering algorithm that may be utilized is average-link clustering, which uses the output of the visualization program. For example, the algorithm may identify boundaries of groups of the publications related to the publications in the subset in the output of the visualization program, generate clusters based on the boundaries and assign all (or a portion) of the publications in the remainder of the corpus to the appropriate clusters. In a preferred exemplary embodiment, there are about 4-100 publications in each cluster, with each cluster being assigned at least one general subject area (e.g., chemistry, biology, engineering, etc.) and at least one discipline within the general subject area (e.g., organic chemistry, physical chemistry, radio chemistry, etc.). Those of skill in the art will understand that the user may generate the clusters for a given period of time and save the results for future use.

In step 220, publications (e.g., a new set, those not included in the subset or the clusters) are assigned to the clusters. In an exemplary embodiment, each publication is assigned to a given cluster based on the citation data for the publication. The publications selected may be from a given time period. For example, if the user wants to identify emerging trends in research at his/her institution/company, the selected publications may be from the previous 2-3 years.

When the clusters have been generated and the publications have been assigned, the exemplary embodiments of the present invention include a display module for visualizing the results. In an exemplary embodiment, the display module may be one or more modules or a software program which is a part of, or independent from, the hardware and/or software used to generate the clusters and assign the publications. Those of skill in the art will understand that the display module may be stored on the server 110 or the client device 105 (or be distributed, having portions on the server 110 and the client device 105).

For this description, the term “competency” refers to a research area, including cross-disciplinary categories. A competency is defined by a cluster, and more particularly, the discipline composition of the cluster, which may include the relative strengths of each discipline within the cluster. Thus, competencies are self-organizing and can be, and often are, multi-disciplinary, as opposed to predefined general subject areas used in traditional research metrics. A “distinctive competency” represents a competency in which the institution has the largest relative market share compared to its peers and competitors active in that same competency. An “emerging competency” represents a competency in which the institution has a substantial or growing market share, but not the largest.

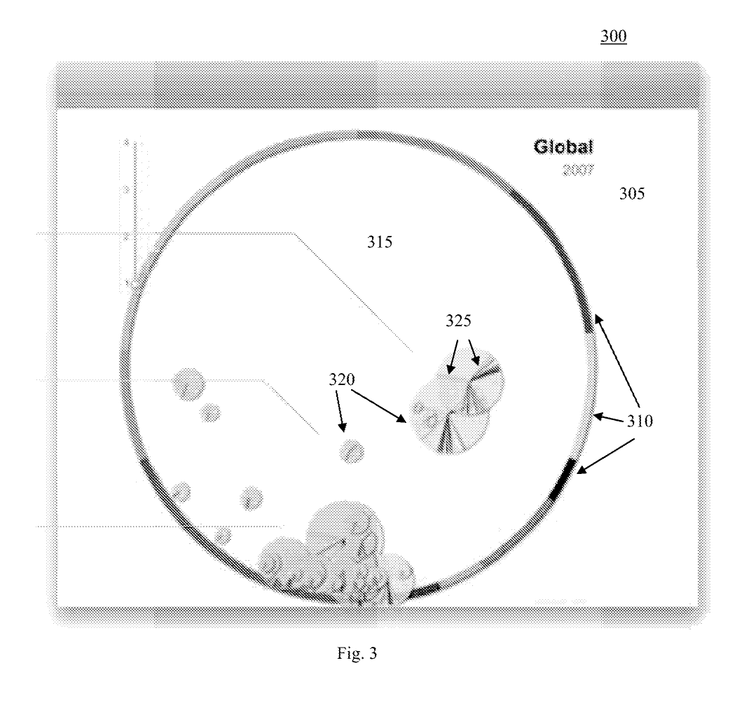

FIG. 3 shows an exemplary embodiment of an output of the display module 300 according to the present invention. The display module 300 may generate a circle map 305 which plots a visual representation of the results of the clustering process. As described above, each of the clusters may be assigned to one or more general subject areas (e.g., chemistry, biology, engineering, etc.) and one or more disciplines within the general subject areas (e.g., organic chemistry, physical chemistry, radio chemistry, etc.)—representing a competency. On the circle map 305, color-coded arcs 310 representing the general subject areas of the clusters may be linked together to form a circumference of the circle map 305. A length of each are may be determined by a number of publications in the cluster. For example, if the cluster for the biology subject area includes 10,000 articles and the cluster for the chemistry subject area includes 1,000 articles, the arc representing the biology subject area may be longer than the arc representing the chemistry subject area. The display module 300 may further generate a key which identifies the color that is assigned to each of the general subject areas. While FIG. 3 shows an exemplary embodiment of the output of the display module as the circle map 305, those of skill in the art will understand that the output of the display module 300 may be any shape or size (e.g., bar graphs, line graphs, pie charts, etc.). Similarly, color-coding or any identifying variant may be used to denote the various general subject areas.

Each of the circles 320, which graphically represent competencies, may be generated and plotted based on various criteria. In a preferred embodiment, a size of a given circle 320 varies based on the number of publications in the cluster, e.g., the more publications, the larger the diameter of the circle 320. Optionally, the size of the circles 320 may be based on the number of publications in the cluster from the user's institution or company. Each of the circles 320 may include one or more subject area identifiers, e.g., lines 325, which identify the general subject areas of the publications in the cluster. For example, the lines 325, when plotted in a given cluster, may point in the direction of (and have the same color as) the arcs that correspond to the general subject areas of the publications in the cluster. A position of a given circle 320 within the interior area 315 of the circle map 305 may be determined by the numbers of publications in corresponding general subject areas in the cluster. For example, the circles 320 that are located closer to a center of the circle map 305 may indicate a multidisciplinary field (e.g., contain publications which are assigned to numerous general subject areas), whereas circles closer to the periphery of the circle map 305 may indicate a more focused field (related to the adjacent general subject area).

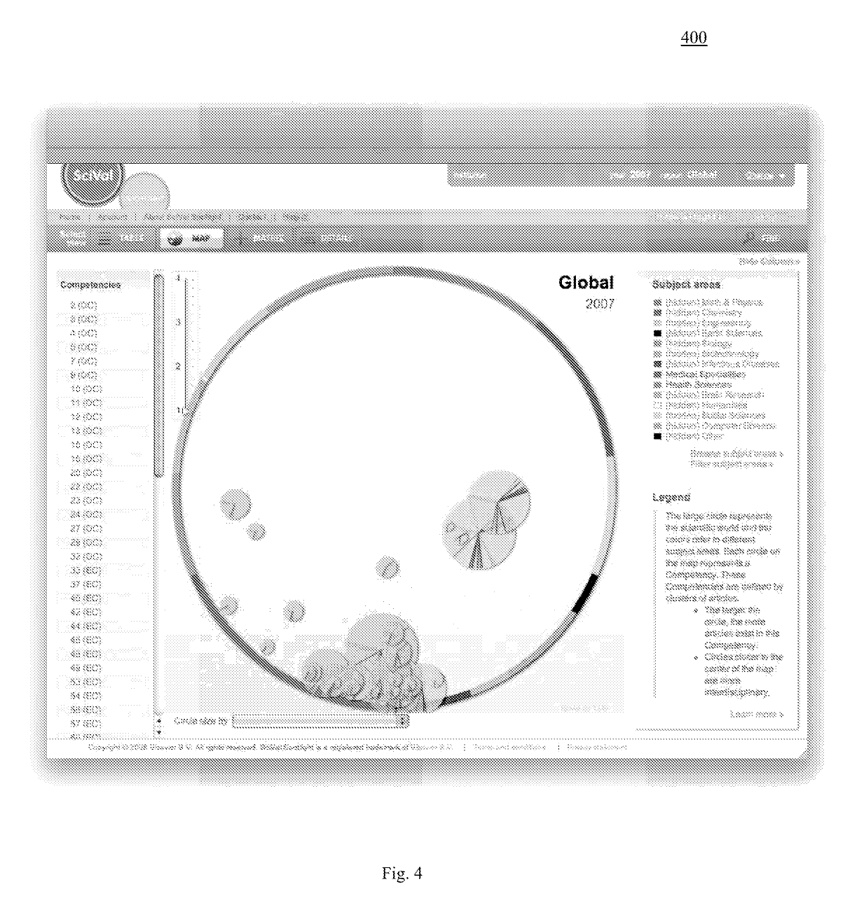

FIG. 4 shows an exemplary embodiment of a cluster view 400 according to the present invention. In the cluster view 400, the user may select (e.g., click, mouseover, gesture on a tactile interface, etc.) a given cluster to view detailed information about the publications in that cluster. The detailed information for a given cluster may include, but is not limited to, a total number of publications, the general subject areas and/or disciplines represented by the publications, a list of authors and number of publications by each author, the authors currently employed by the user's institution/company (or another selected entity, e.g., a competitor), the institutions listed on the publications (optionally, ranked in order of number of publications), other clusters in which a given author(s) publication(s) are included, and a list of keywords from the publications.

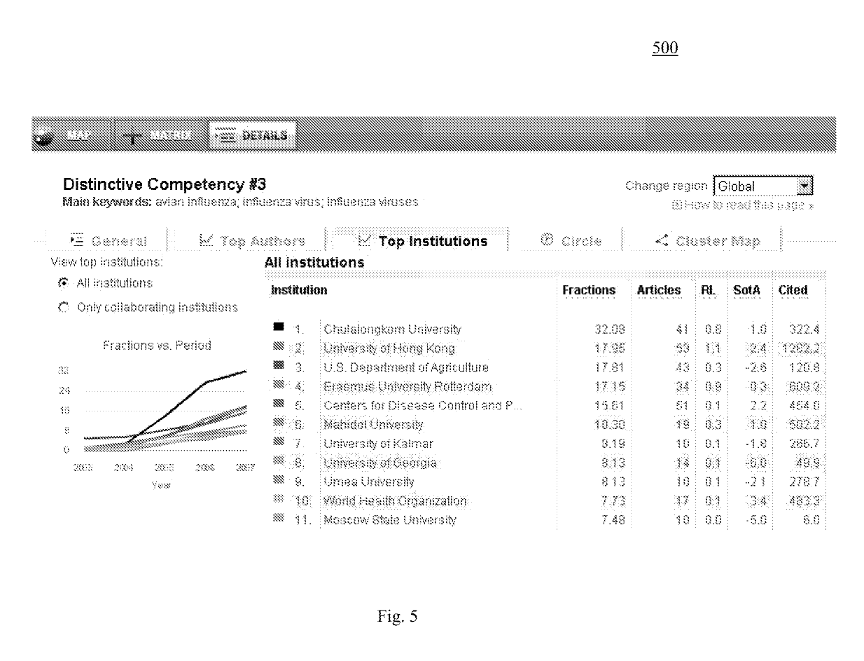

The detailed information may be presented in table form in a detail view 500, as shown in FIG. 5. From the detail view 500, the user may determine a percentage of an institution's research market share for a particular competency. The user may also view percentages of research market shares for a particular competency of his peers or competitors. The research market share may be determined by, for example, the number of publications from an institution within a competency, the number of citations to publications from an institution within a competency, and/or the date of the publications from an institution (the latter used to identify emerging competencies).

In one embodiment, the system also calculates or obtains the global, national, and/or peer/competitor growth rates of articles within a competency. Using this data, the system or a user can compare an institution's growth rate in a competency compared to the global growth rate, the national growth rate, and/or the growth rate of peer/competitor institutions. For example, an institution is a leader in a particular competency, but its growth rate is 0.05% per year compared to the global growth rate of 3.0% per year. Using this information, the system could suggest, or a user could determine, that the institution is at risk of losing their leadership position within the competency. Using this evaluation, the institution may wish to establish or adjust their strategic direction. For example, the institution may wish to retain their leadership position in this competency, so they may decide to allocate greater funding to this area (or the multiple areas that comprise the competency) and/or they may decide to recruit/retain skilled researchers in the competency.

In one aspect, the system can determine the top authors within a competency. For example, the system could make this determination based on author publication count and author citation count (number of times the author was cited) within a competency. Continuing with the example from the previous paragraph, the institution attempting to retain (or raise) their leadership position within the competency by recruiting/retaining skilled researchers may execute this strategy by utilizing the author ranking information.

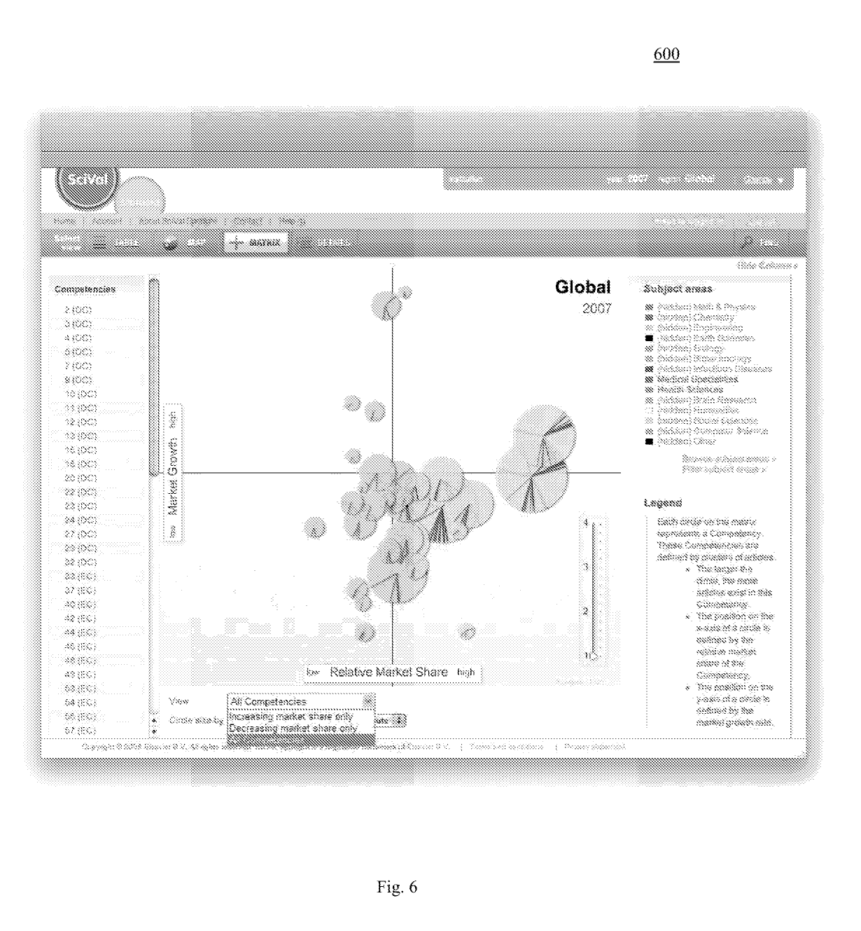

FIG. 6 shows an exemplary embodiment of a matrix view 600. The matrix view 600 may be organized as a two-dimensional plane with the circles 320 being plotted on (x,y) coordinates. In the exemplary embodiment, an x-axis of the plane may measure relative market share, and a y-axis may measure market growth. By plotting the circles 320 on these axes, the user may visually identify the clusters in which the institution/company is increasing/decreasing publication output and/or emerging areas of research. This powerful graphic could help a user establish and implement a strategic research plan. For example, a user may wish to allocate internal funds to competencies that have high market growth, but low relative market share to develop emerging competencies. Before the present invention, these competencies could easily be overlooked because of their smaller footprint—and would be even more likely to be overlooked if they were multidisciplinary.

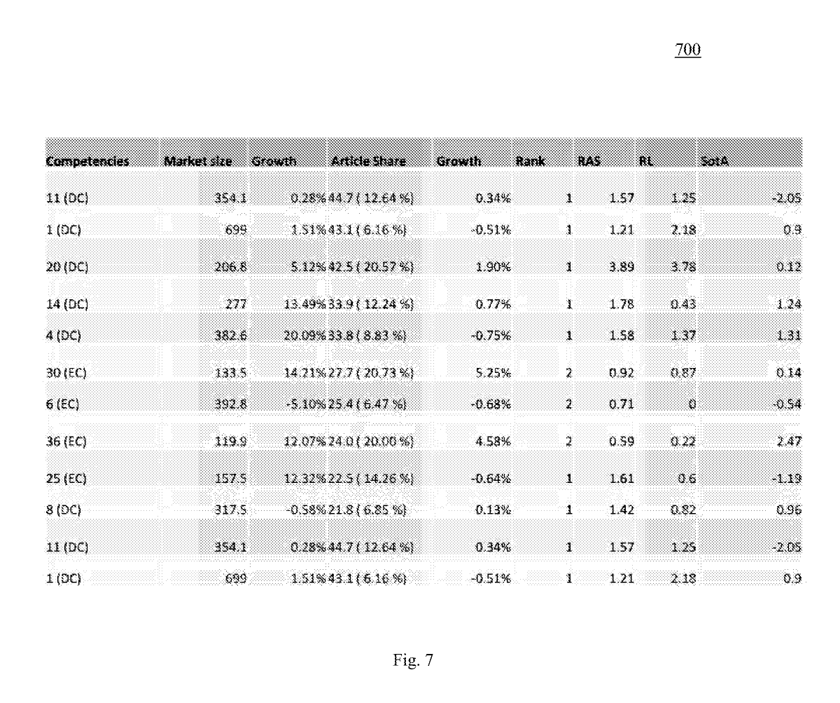

FIG. 7 shows an exemplary embodiment of a table view 700. The table view 700 may present evaluation information in text format. For example, the columns may include competency, market size/market growth, article share/article growth, rank, State of the Art (SotA), Relative Article Share (RAS), and Reference Leadership (RL). SotA is a measure indicating the recentness of articles cited by the institution's articles within a competency. The measure varies around zero. Positive values indicate that the institution is citing more recent work within the competency than the world as a whole. Negative values indicate that the institution is citing older work than the world as a whole. The calculation is done by taking the median reference year for each individual article within a competency and comparing the average value of an institution to the average of the whole competency. RAS is defined as the number of publications authored by an institution, divided by the number of publications authored by the institution's largest competitor within a particular competency, during a publication window, for example, 5-years. RL is calculated the same way as RAS except using only highly-cited reference articles from the publication window. “Highly-cited” may be defined by a preset threshold or be dynamic, for example, based on percentiles. Using these measurements, the system or a user could quickly and effectively evaluate an institution's research output and/or capabilities. A university, for example, with a RAS of 0.67, indicates the university's authors publish 0.67 articles in this competency for every one that an elite university publishes, and an RL of 0.05 indicates that their articles are referenced half as often as the elite university for this competency. In another example, a university has a RAS of 2.05, a RL of 1.5, and a SotA of 0.5, for a particular competency. This indicates that the university is highly established in this area of research, has seminal work in the area, and continues to lead the way by quickly building upon their own discoveries.

Thus, the system allows decision-makers to effectively evaluate their institution's research output in a single interface, and accordingly, establish or adjust their institution's strategic direction based on evidence and data.

In one embodiment, the system or user may determine the top authors and/or top institutions, as discussed above, and use this information to execute a research strategy—such as maintain a leadership position. To continue with the preceding example, the system or user may determine that the university's authors, for the competency in question, have collaborated with one of the top three authors and one of the top three institutions. Conversely, the system or user determines that there is no evidence of collaboration with the other top two authors or institutions. To preserve the university's leadership position in this competency, the system may suggest considering future collaboration opportunities with the other two authors and/or institutions.

As understood by those of skill in the art, the user may toggle between different views by selecting different presentation options or tabs within the display module 300. Similarly, the user may manipulate different views, customize the data being shown on the different views, and/or save different views for future use and/or comparison.

Increasing the amount of competitive funds gained at the institutional level could be accomplished if the institution identifies its true research strengths and maximizes relevant funding opportunities. However, traditional methods of measuring research competencies no longer capture the reality of today's multinational and multidisciplinary research. Institutions that adopt new performance evaluation methods, such as those described above, could be in a better position to leverage those areas where they exhibit true leadership to compete in the current funding environment.

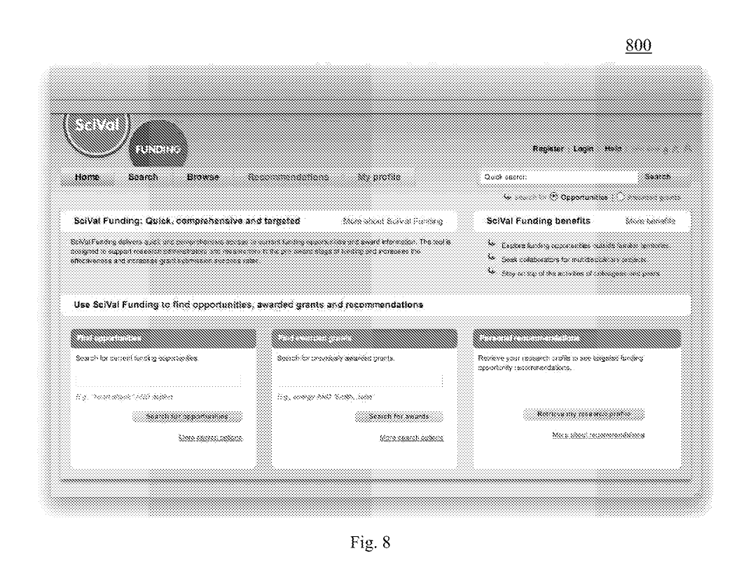

In another aspect of the present invention, the system 100 may contain a funding tool. The system 100 may obtain funding data from database 115. FIG. 8 shows an exemplary embodiment of a funding interface 800 to the funding data in the database 115. The interface 800 may include a plurality of search options for allowing the user to search the funding data in the database 115. For example, the search options may include searching for funding opportunities, awards and submitted requests. The database 115 may store information about funding programs for a plurality of different sources, public (e.g., NSF, NIH, etc.) and private (e.g., venture capital, angel, private-sector co-sponsorship, etc.). The funding interface 800 may, therefore, be a portal to an aggregated database of funding opportunities from different funding programs. Those of skill in the art will understand that the funding data in the database 115 may be updated by the user (or someone at his institution/company), a third-party (e.g., a funding source), or a pushed/pulled data feed from publicly-available sources (e.g., web searches or directly from funding source databases).

The user may create a profile in the system 100 which allows the server 110 to match the funding data to the user's profile. For example, the profile may include the user's demographic information, institution/company, and/or research focus area(s) and/or may include alert options that notify the user when funding opportunities matching the user's profile arise and/or the status of submitted funding requests. In a preferred embodiment, the funding tool is integrated with the research evaluation systems and methods discussed above. Optionally, the funding tool may suggest funding opportunities suited to an institution's particular competencies.

In one embodiment, the tool may determine whether and/or which competencies are overfunded and/or underfunded. For example, the system may compare the amount of funding received in recent years to prior years, with regard to particular competencies, and determine which areas have experienced a decrease in funding and/or which have experienced an increase in funding. Using this information, certain thresholds may be set to determine if an area in underfunded or overfunded. Optionally, this determination can also take into consideration competency growth rates and/or market shares. For example, a university had a 30% decrease in funding in a high growth rate competency and the university also holds a relatively small market share for the competency. Using this information, the system or user may determine that this competency is underfunded and further resources should be sought or allocated to the area. The system may also indicate that a particular competency with a high market share is particularly suited for certain grants related to that competency.

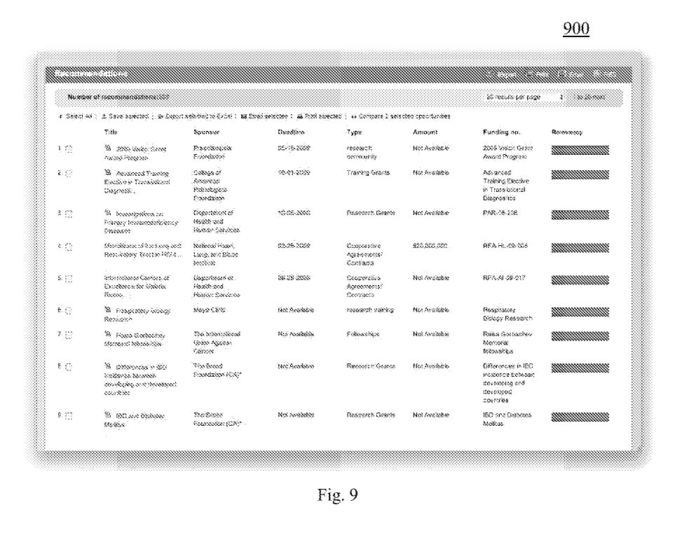

FIG. 9 shows an exemplary embodiment of a funding recommendation page 900, which may be generated when the user requests the funding data that is identified as a match for his profile. The recommendation page 900 may include data for a plurality of funding opportunities and may rank the opportunities in an order of relevance, based on a degree to which they match the user's profile. The data for the funding opportunities may include, for example, a title of the funding opportunity, a sponsor, an application deadline, a type (e.g., research, training, cooperatives, fellowships, etc.), an amount, a serial number associated with the opportunity, a visual indicator (or numerical percentage) representing the degree to which the funding opportunity matches the user's profile, a link to a source of the funding opportunity, and a link to an application for the funding opportunity. Those of skill in the art will understand that if the user chooses to fill-out or create an application for the funding opportunity, the application may be pre-populated with the user's information, e.g., from his profile.

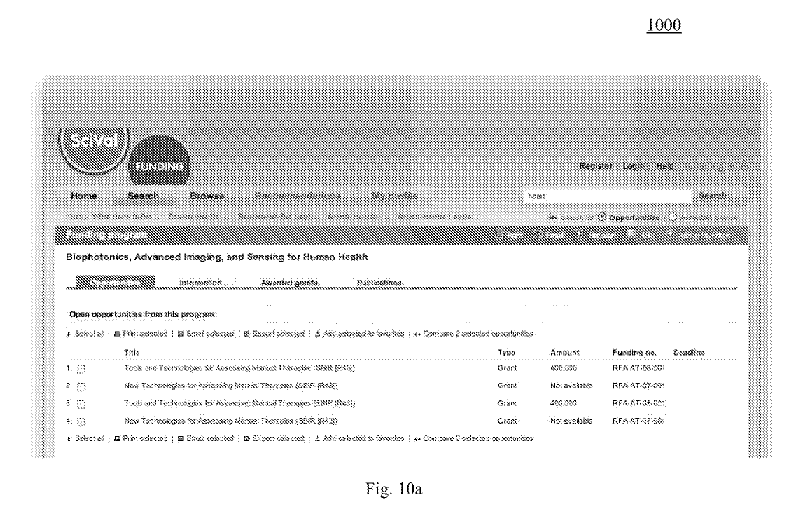

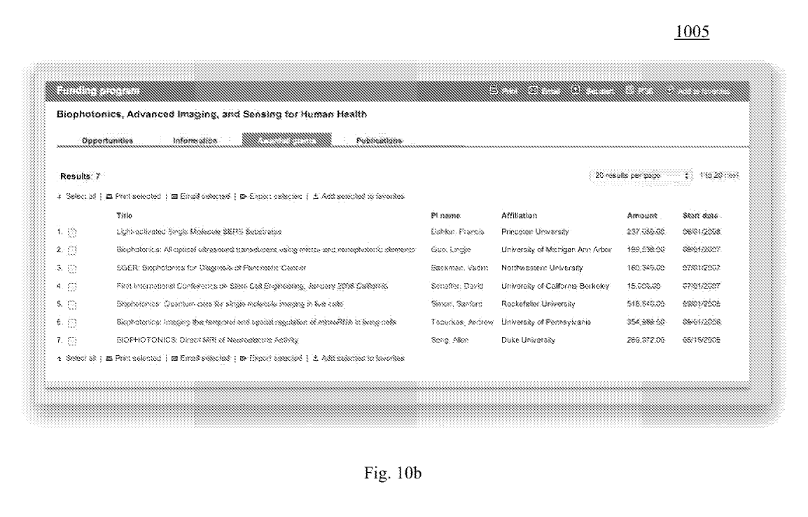

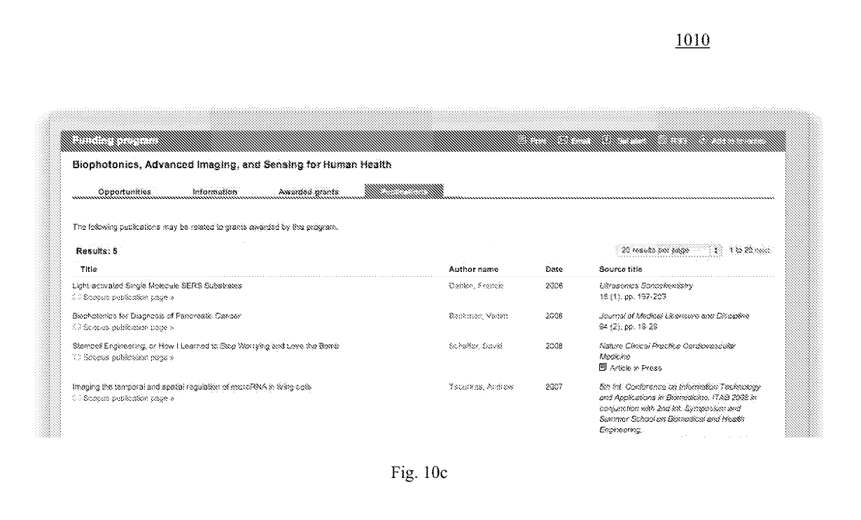

FIG. 10a-c show exemplary embodiments of pages providing information about a specific funding program or source. For example, FIG. 10a shows an exemplary embodiment of an opportunities page 1000 which identifies funding opportunities available from the funding program, and may include information such as a title/name of the funding opportunity, the type of funding opportunity, the amount of funding and a serial number for the funding opportunity. FIG. 10b shows an exemplary embodiment of an awards page 1005 which identifies awards granted by the funding program, and may include information such as the title/name of the funding opportunity, a name of a principal investigator awarded the funding, an affiliation of the principal investigator, an amount of the funding awarded and a date of the award. FIG. 10c shows an exemplary embodiment of a publications page 1010 which identifies publications which may be related to the funding supplied by the funding program, and may include information such as a title of the publication, authors of the publication, a date of the publication and a publication source (e.g., journal name).

Using the information provided by the funding interface 800, users can access the award data for funding performance measurement, evaluation and strategic planning, learn which publications are linked to certain funding programs, gain insight into funding history for the funding program, identify those researchers have received funding in the past, etc. As understood by those of skill in the art, the user may customize the funding interface 800 to his institution such that the output of the awards and publications pages 1005, 1010 display the funding awards received by and publications of his institution. Further, the user may search utilize the funding interface to track and/or measure funding awards and publications from competitor institutions/companies and for identifying those researchers who receive the most funding or who have received the most recent funding (and in a particular discipline or general subject area).

While particular elements, embodiments, and applications of the present invention have been shown and described, those of skill in the art will understand that the invention is not limited thereto, since modifications may be made, particularly in light of the foregoing teaching. The appended claims are intended to encompass all such modifications that come within the spirit and scope of the invention. Although multiple embodiments are described herein, those embodiments are not necessarily distinct—features may be shared across embodiments.

What is claimed is:

1. A computer implemented method for evaluating the research performance of an institution comprising:
selecting a time-period;
selecting a plurality of references from said time-period, associated with said institution;
calculating, via one or more processors, the relatedness between the references in said plurality of references;
clustering two or more said references based on said calculated relatedness;
outputting, in a user readable format, at least one of: at least one of said institution's competencies that is underfunded, and at least one of said institution's competencies that is overfunded.

2. The method of claim 1 wherein said output is displayed graphically.

3. The method of claim 1 wherein said output comprises text.

4. The method of claim 2 wherein said graphic output comprises competency circles plotted on a graph with a first axis indicating market grown and a second axis indicating relative market share.

5. The method of claim 3 wherein said text output comprises a percentage of research market share for a particular competency of said institution.

6. The method of claim 5 wherein said text output further comprises a percentage of the market share for said particular competency, of a peer or competitor of said institution.

7. The method of claim 1 wherein selecting a set of references comprises:
selecting at least one threshold citation number;
selecting only those references which are cited at least as much as the corresponding threshold citation number;

8. The method of claim 1 wherein said set of references contains at least 1 million references to eliminate disciplinary bias.

9. The method of claim 1 wherein said at least one threshold citation number comprises at least two threshold citation numbers each corresponding to different reference ages;

10. The method of claim 9 further wherein the threshold citation number corresponding to a lower reference ages is lower than the threshold citation number corresponding to a higher age range.

11. The method of claim 1 wherein said relatedness is calculated by co-citation analysis.

12. The method of claim 11 wherein said co-citation analysis comprises:
generating a matrix of values using a modified cosine index based on co-citation counts for similarity; and
running said matrix through a visualization program in order to assign each reference paper an x-y coordinate position on a two-dimensional plane.

13. The method of claim 1 wherein said clustering is performed using an unsupervised algorithm.

14. The method of claim 13 wherein said unsupervised algorithm is average-link clustering tailored to work with a co-citation analysis which produces x-y coordinate positions on a two-dimensional plane, for each reference.

15. The method of claim 1 wherein said time-period is one year.

16. A system for evaluating the research performance comprising:
a processor operable to calculate the relatedness between the references in a plurality of references;
said processor further operable to cluster said references based on said calculated relatedness; and
a module programmed to output, in a user readable format, at least one of: at least one of said institution's competencies that is underfunded, and at least one of said institution's competencies that is overfunded.

17. A system, comprising
a database storing funding data for a plurality of research funding programs, the funding data including data regarding funding opportunities sponsored by each of the plurality of funding programs and funding awards granted by each of the plurality of funding opportunities; and
a server providing an interface to the database for allowing a user to query the database.

18. The system according to claim 17, wherein the database receives the funding data from at least one of the plurality of research funding programs.

19. The system according to claim 17, wherein the database stores a user profile including a list of at least one desired funding opportunity.

20. The system according to claim 19, wherein the server transmits an output message when a funding opportunity from one of the plurality of research funding programs matches a desired funding opportunity on the list.
